(19) United States
(12) Patent Application Publication
(10) Pub. No.: US 2026/0227011 A1
(43) Pub. Date: Aug. 6, 2026

(54) METHODS AND SYSTEMS FOR CONNECTING PIPES

(71) Applicant: SAUDI ARABIAN OIL COMPANY, Dhahran (SA)

(72) Inventors: Francisco Daniel Nieves Bogonez, Claverham (GB); Abderrazak Traidia, Lussan (FR); Thibault Villette, Belfort (FR)

(73) Assignee: SAUDI ARABIAN OIL COMPANY, Dhahran (SA)

(21) Appl. No.: 19/042,870

(22) Filed: Jan. 31, 2025

(51) Int. Cl. F16L 13/02; F16L 58/18

(52) U.S. Cl. CPC F16L 13/0263; F16L 13/0272; F16L 58/181

(57) ABSTRACT

Systems and methods for connecting reinforced pipes use a coupler and a spacer. The spacer includes a welding port configured to receive an electrode; a cavity configured to receive an electrical connector of a coupler; and an inner diameter. The coupler is configured to be disposed inside a first connection end of a first pipe and a second connection end of a second pipe. The coupler includes an electrical connector and an embedded coil. The embedded coil is wrapped circumferentially around the coupler and is configured to emit heat when a first current is applied. The spacer is configured to receive the coupler within the inner diameter.

### BACKGROUND

Production systems produce hydrocarbons from production wells. The produced hydrocarbons are transported through production pipelines. The production pipelines are formed from one or more pipes that are connected together by connection systems. The production pipelines are susceptible to structural failures due to corrosion at the connection systems. Many connection systems are formed from metallic components. Produced hydrocarbons flowing through the pipelines can interact with the metallic components forming a corrosive reaction to the metallic components resulting in structural failure in the metallic components. There is a need for an improved non-corrosive connection system to improve production pipelines and to help mitigate pipeline failures which result in hydrocarbon spills that may damage the environment.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a method for connecting a first pipe and a second pipe to form a pipeline. The method includes disposing a first flange on a first connection end of the first pipe and a second flange on a second connection end of the second pipe. The method includes aligning axially the first pipe and the second pipe so that the first connection end and the second connection end are adjacent. Each pipe may include an inner liner. The method includes disposing a first plurality of wedges on the first connection end of the first pipe. The first plurality of wedges may be disposed circumferentially around the first connection end. The method includes disposing a second plurality of wedges on the second connection end of the second pipe. The second plurality of wedges may be disposed circumferentially around the second connection end. The method includes disposing, at least partially, a coupler inside the first connection end and the second connection end. The coupler may include an electrical connector and an embedded coil. The embedded coil may be wrapped circumferentially around the coupler and is configured to emit heat when a first current is applied. The method includes translating the first pipe and the second pipe toward a spacer disposed on the coupler at a spacer location so that each pipe is adjacent to the spacer. The spacer includes a welding port and a cavity. The cavity is configured to receive the electrical connector. The method includes translating, at least partially, the first flange and the second flange towards each other so as to compress the first plurality of wedges against the first connection end by the first flange and the second plurality of wedges against the second connection end by the second flange. The method includes inserting an electrode into the welding port so that the electrode is electrically coupled to the electrical connector. The method includes applying, using a power supply, a first current to the embedded coil via the electrical connector bonding the coupler to the inner liner of each of the first pipe and the second pipe yielding a connection joint; removing the electrode from the welding port. The method includes securing, using a securing system, the connection joint by further translating the first flange and the second flange to a pre-determined tolerance of compression.

In some aspects, the techniques described herein relate to a system for connecting a first pipe and a second pipe to form a pipeline. The system includes a first flange configured to dispose on the first pipe having a first connection end. The system includes a second flange configured to dispose on the second pipe having a second connection end. The system includes a first plurality of wedges configured to be disposed circumferentially around the first connection end of the first pipe. The system includes a second plurality of wedges configured to be disposed circumferentially around the second connection end of the second pipe. The first flange is configured to compress the first plurality of wedges against the first connection end. The second flange is configured to compress the second plurality of wedges against the second connection end by the second flange. The system includes a coupler configured to be disposed inside the first connection end and the second connection end. The coupler includes an electrical connector and an embedded coil. The embedded coil is wrapped circumferentially around the coupler and is configured to emit heat when a first current is applied. The system includes a spacer configured to be disposed at a spacer location along the coupler between the first connection end and the second connection end. The spacer includes a welding port and a cavity. The cavity is configured to receive the electrical connector. The system includes an electrode configured to insert into the welding port so that the electrode is electrically coupled to the electrical connector and apply the first current to the electrical connector. The system includes a power supply configured to apply the first current to the embedded coil via the electrical connector to bond the coupler to the first connection end and the second connection end yielding a connection joint. The system includes a securing system configured to secure the connection joint by further translating the first flange and the second flange to a pre-determined tolerance of compression.

In some aspects, the techniques described herein relate to a spacer. The spacer includes a welding port configured to receive an electrode, a cavity configured to receive an electrical connector of a coupler, and an inner diameter. The spacer is configured to receive the coupler within the inner diameter.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example well environment performing production operations that may use a pipe connection system in accordance with one or more embodiments.

FIG. 2 depicts a cutaway view of a pipe in accordance with one or more embodiments.

FIG. 3 depicts an oblique view of a pipe connection system in accordance with one or more embodiments.

FIG. 4 depicts a perspective view of a coupler in accordance with one or more embodiments.

FIG. 5A depicts a perspective view of a spacer in accordance with one or more embodiments.

FIG. 5B depicts a cross-sectional view of a spacer in accordance with one or more embodiments.

FIG. 6 depicts an oblique view of an assembly of a coupler and a spacer in accordance with one or more embodiments.

FIG. 7 illustrates an exploded view of a pipe connection system in accordance with one or more embodiments.

FIG. 8 depicts a perspective view of a pipe connection system in accordance with one or more embodiments.

FIG. 9 illustrates an axial cross-sectional view of a pipe connection system in accordance with one or more embodiments.

FIG. 10 depicts an axial cross-sectional view of a pipe connection system and a bonding system in accordance with one or more embodiments.

FIG. 11A-11B depict a flowchart of a pipe connection method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise.

Terms such as “approximately,” “substantially,” “about,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

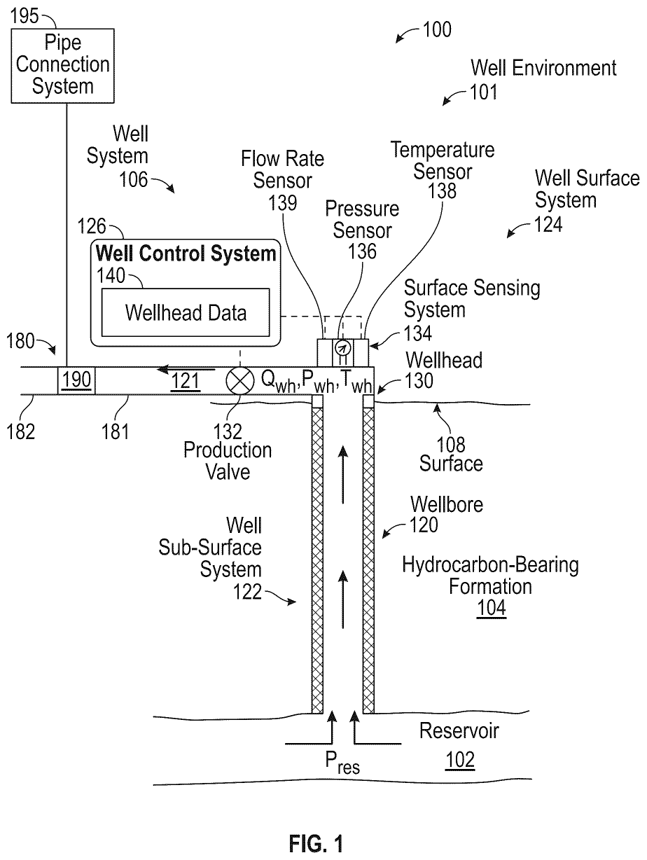

In the following description of FIGS. 1-11, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Methods and systems for connecting a plurality of pipes to form a pipeline are disclosed herein. A system for connecting a plurality of pipes may include a coupler, a spacer, a first flange, a first plurality of wedges, a second flange, a second plurality of wedges, and a connection system. Each pipe includes a plurality of pipe layers such as a pipe inner line, a pipe reinforcement layer, and a pipe encapsulating layer. The coupler includes a plurality of coupler layers such as a coupler inner liner, a coupler reinforcement layer, and a coupler encapsulating layer. The coupler may include an electrical connector for connecting to an electrode and an embedded coil operatively connected to the electrical connector and configured to emit heat. The coupler is disposed within a first pipe and a second pipe. The spacer is disposed circumferentially around the coupler at a location along a coupler axial length between the first pipe and the second pipe. The first flange and the first plurality of wedges are disposed on the first pipe. The second flange and the second plurality of wedges are disposed on the second pipe. The spacer includes a cavity that is configured to receive the electrical connection. The first flange and the second flange are translated together using a connection system so that each flange and each plurality of wedges compress each pipe to seal the connection joint. The electrode is connected to the electrical connector and current is supplied from a power supply to heat each embedded coil thereby melting each pipe inner liner and the coupler encapsulating layer to form a connection joint that is leak-free.

FIG. 1 shows an example embodiment of a well environment with a schematic diagram of a system for flowing production fluid through a pipeline (hereafter “pipeline system” (100)) in accordance with one or more embodiments. More specifically, FIG. 1 illustrates a well environment (101) that includes a hydrocarbon reservoir (“reservoir”) (102) located in a hydrocarbon-bearing formation (104) and a well system (106). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102).

In some embodiments, the well system (106) includes a wellbore (120), a well sub-surface system (122), a well surface system (124), and a well control system (126). The well control system (126) may control various operations of the well system (106), such as well production operations, well completion operations, well maintenance operations, and reservoir monitoring, assessment and development operations. In some embodiments, the well control system (126) includes a computer system.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production fluid”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

In some embodiments, during operation of the well system (106), the well control system (126) collects and records wellhead data (140) for the well system (106). The wellhead data (140) may include, for example, a record of measurements of wellhead pressure (Pwh) (e.g., including flowing wellhead pressure), wellhead temperature (Twh) (e.g., including flowing wellhead temperature), wellhead production rate (Qwh) over some or all of the life of the well, and water cut data. In some embodiments, the measurements are recorded in real-time, and are available for review or use within seconds, minutes or hours of the condition being sensed (e.g., the measurements are available within 1 hour of the condition being sensed). In such an embodiment, the wellhead data (140) may be referred to as “real-time” wellhead data (140). Real-time wellhead data (140) may enable an operator of the well to assess a relatively current state of the well system (106), and make real-time decisions regarding development of the well system (106) and the reservoir (102), such as on-demand adjustments in regulation of production flow from the well.

In some embodiments, the well sub-surface system (122) includes casing installed in the wellbore (120). For example, the wellbore (120) may have a cased portion and an uncased (or “open hole”) portion. The cased portion may include a portion of the wellbore having casing (e.g., casing pipe and casing cement) disposed therein. The uncased portion may include a portion of the wellbore not having casing disposed therein. In some embodiments, the casing includes an annular casing that lines the wall of the wellbore (120) to define a central passage that provides a conduit for the transport of tools and substances through the wellbore (120). For example, the central passage may provide a conduit for lowering logging tools into the wellbore (120), a conduit for the flow of production fluid (121) (e.g., oil and gas) from the reservoir (102) to the surface (108), or a conduit for the flow of injection substances (e.g., water) from the surface (108) into the hydrocarbon-bearing formation (104). In some embodiments, the well sub-surface system (122) includes production tubing installed in the wellbore (120). The production tubing may provide a conduit for the transport of tools and substances through the wellbore (120). The production tubing may, for example, be disposed inside casing. In such an embodiment, the production tubing may provide a conduit for some or all of the production fluid (121) (e.g., oil and gas) passing through the wellbore (120) and the casing.

In some embodiments, the well surface system (124) includes a wellhead (130). The wellhead (130) may include a rigid structure installed at the “up-hole” end of the wellbore (120), at or near where the wellbore (120) terminates at the surface (108). The wellhead (130) may include structures for supporting (or “hanging”) casing and production tubing extending into the wellbore (120). Production fluid (121) may flow through the wellhead (130), after exiting the wellbore (120) and the well sub-surface system (122), including, for example, the casing and the production tubing. In some embodiments, the well surface system (124) includes flow regulating devices that are operable to control the flow of substances into and out of the wellbore (120). For example, the well surface system (124) may include one or more production valves (132) that are operable to control the flow of the production fluid (121). For example, a production valve (132) may be fully opened to enable unrestricted flow of production fluid (121) from the wellbore (120) through a pipeline (180), the production valve (132) may be partially opened to partially restrict (or “throttle”) the flow of production fluid (121) from the wellbore (120), and production valve (132) may be fully closed to fully restrict (or “block”) the flow of production fluid (121) from the wellbore (120), and through the well surface system (124).

In some embodiments, the wellhead (130) includes a choke assembly. For example, the choke assembly may include hardware with functionality for opening and closing the fluid flow through pipes in the well system (106). Likewise, the choke assembly may include a pipe manifold that may lower the pressure of fluid traversing the wellhead (130). As such, the choke assembly may include a set of high-pressure valves and at least two chokes. These chokes may be fixed or adjustable or a mix of both. Redundancy may be provided so that if one choke has to be taken out of service, the flow can be directed through another choke. In some embodiments, pressure valves and chokes are communicatively coupled to the well control system (126). Accordingly, the well control system (126) may obtain the wellhead data (140) regarding the choke assembly as well as transmit one or more commands to components within the choke assembly in order to adjust one or more choke assembly parameters.

Keeping with FIG. 1, in some embodiments, the well surface system (124) includes a surface sensing system (134). The surface sensing system (134) may include sensors for sensing characteristics of substances, including production fluid (121), passing through or otherwise located in the well surface system (124). The characteristics may include, for example, pressure, temperature and flow rate of production fluid (121) flowing through the wellhead (130), or other conduits of the well surface system (124), after exiting the wellbore (120).

In some embodiments, the surface sensing system (134) includes a surface pressure sensor (136) operable to sense the pressure of the production fluid (121) flowing through the well surface system (124), after it exits the wellbore (120). The surface pressure sensor (136) may include, for example, a wellhead pressure sensor that senses a pressure of production fluid (121) flowing through or otherwise located in the wellhead (130). In some embodiments, the surface sensing system (134) includes a surface temperature sensor (138) operable to sense the temperature of the production fluid (121) flowing through the well surface system (124), after it exits the wellbore (120). The surface temperature sensor (138) may include, for example, a wellhead temperature sensor that senses a temperature of production fluid (121) flowing through or otherwise located in the wellhead (130), referred to as “wellhead temperature” (Twh). In some embodiments, the surface sensing system (134) includes a flow rate sensor (139) operable to sense the flow rate of the production fluid (121) flowing through the well surface system (124), after it exits the wellbore (120). The flow rate sensor (139) may include hardware that senses the flow rate of production fluid (Qwh) passing through the wellhead (130).

In some embodiments, the pipeline system (100) includes the pipeline (180) formed from a plurality of pipes (181, 182). Each pipe (e.g., a first pipe (181)) may be connected to another one of the plurality of pipes (e.g., a second pipe (182)) at a connection joint (190). A system for connecting the first pipe (181) and the second pipe (182) to form the pipeline (180) (hereafter “pipe connection system” (195) may be used to form the connection joint (190). In some embodiments, each pipe (e.g., first pipe (181) and the second pipe (182)) may be a reinforced thermoplastic pipe (“RTP”). The pipeline (180) is configured to transport the production fluid (121) with minimal corrosive interaction between the production fluid (121) and the connection joint (190). It will be apparent to those skilled in the art that a pipeline may be used with various systems other than a well environment and well system. The well environment (101) is only an example embodiment and should not be considered limiting to the scope of the invention.

While FIG. 1 shows various configurations of components, other configurations may be used without departing from the scope of the disclosure. For example, various components in FIG. 1 may be combined to create a single component. As another example, the functionality performed by a single component may be performed by two or more components.

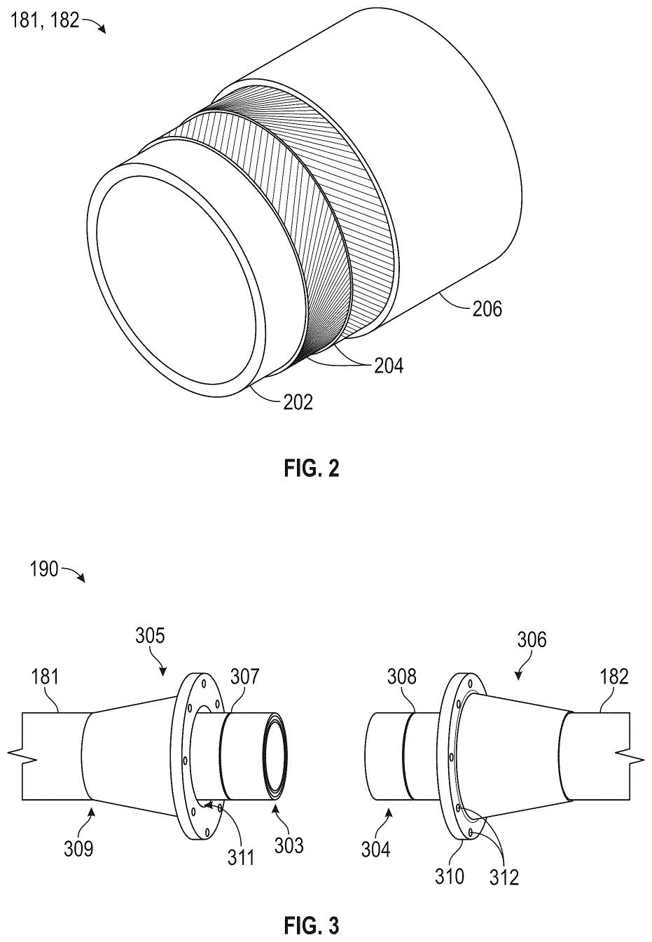

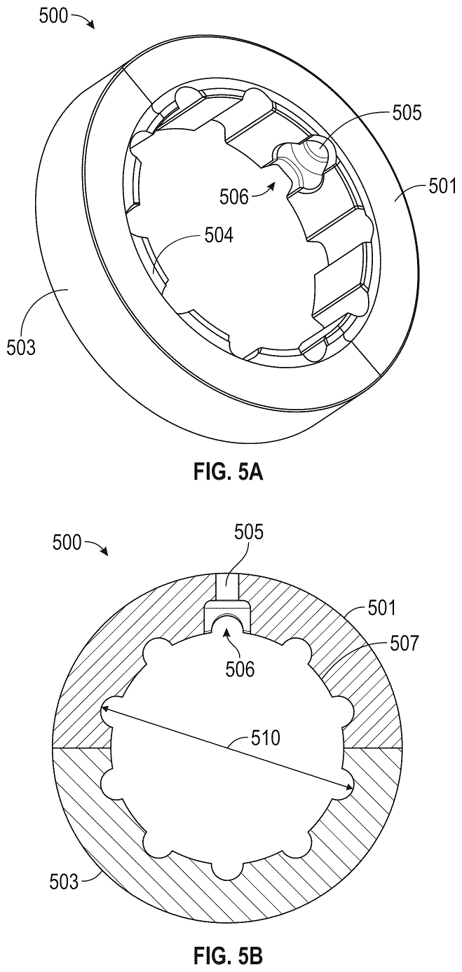

In accordance with one or more embodiments, FIG. 2 depicts a cutaway view of a reinforced pipe (e.g., the first pipe (181) and the second pipe (182)) and/or a coupler constructed using reinforced pipe such as a coupler (400) as described in relation to FIG. 4. The reinforced pipe may be a Reinforced Thermoplastic Pipe (RTP) or a Thermoplastic Composite Pipe (TCP) known to those skilled in the art. Each pipe and/or coupler includes a reinforcement layer (e.g., a pipe reinforcement layer (204) and/or a coupler reinforcement layer) and an encapsulating layer (e.g., a pipe encapsulating layer (206) and/or a coupler encapsulating layer). In some embodiments, each pipe and/or coupler may include an inner liner (e.g., pipe inner liner (202) and/or a coupler inner liner). The inner liner is configured to allow flow of the production fluid (121). In some embodiments, the coupler may include the coupler encapsulating layer and the coupler reinforcement layer but not the coupler inner liner in order to minimize the coupler's overall thickness.

In some embodiments, the inner liner and/or the encapsulating layer may be formed by any method know to those skilled in the art. In some embodiments, the various layers such as the inner liner and the coupler encapsulating layer may be constructed from a non-metallic material. The inner liner, the reinforcement layer, and/or the encapsulating layer may be formed with any thickness needed. The range of the thickness (i.e., outside diameter minus inside diameter) of the inner liner, the reinforcement layer, and/or the encapsulating layer may have any thickness that is suitable for production fluid flow and may depend upon the desired pressure rating, the composition of the liner, the reinforcement layer properties, and other factors known to one skilled in the art.

The inner liner (e.g., the pipe inner liner (202) and/or the coupler inner liner) and/or the encapsulating layer (e.g., a pipe encapsulating layer (206) and/or a coupler encapsulating layer) according to some embodiments herein may be formed from natural or synthetic rubbers or other man-made polymers as known in the art. The polymers used to form the inner liner, the reinforcement layer, and/or the encapsulating layer may be selected based on the properties of the material to be conveyed or handled in the spoolable composite pipes and pressure vessels according to embodiments herein. The inner liner and/or the encapsulating layer may include a polymeric material such as a thermoplastic. In some embodiments, liners and layers useful in embodiments herein may be formed from polyethylenes such as ultra-high molecular weight polyethylene (UHMWPE), high density polyethylene (HDPE), or medium density polyethylene (MDPE), or from other materials such as polyethylene of raised temperature (PE-RT), polyvinylidene fluoride (PVDF), polyamide (PA), polyphenylene sulfide (PPS), or polyketone (POK).

The reinforcement layer (e.g., a pipe reinforcement layer (204) and/or a coupler reinforcement layer) may include any reinforced polymer known to those skilled in the art. For example, the reinforcement layer may include prepreg fabric or a fiber reinforced layer formed as a tape for example. In some embodiments, the fabric may be a woven, a cross-ply, or a nonwoven fabric, or other fabrics with a resin applied and consolidated. In other embodiments, the fabric may be constructed of fibers that may include, but are not limited to, carbon fiber, glass fiber, aramid fiber, or basalt fiber.

In one or more embodiments, the fiber may be present in a volume fraction of the reinforcement layer in the range from approximately 20 vol % to approximately 80 vol %, for example with a lower limit of any of 20 vol %, 30 vol %, or 40 vol % to an upper limit of any of 60 vol %, 70 vol %, or 80 vol %, where any lower limit may be used in combination with any upper limit. The fibers may be any length suitable for reinforcement of the layer material or may be continuous fibers. The fiber reinforced layer may be formed from a polymeric material such as thermoplastic. The fiber reinforced layer may include fibers that may include, but are not limited to, carbon fiber, glass fiber, aramid fiber, or basalt fiber.

Each pipe (181, 182) may be constructed in continuous lengths that may be significantly longer along a pipe axis than typical pipe, such as steel pipe which is typically 30 or 31 ft in length along the pipe axis. The reinforced pipe, such as RTP pipe, used to construct each pipe (181, 182) and/or coupler may be spooled on a reel after being manufactured for storage and/or transport.

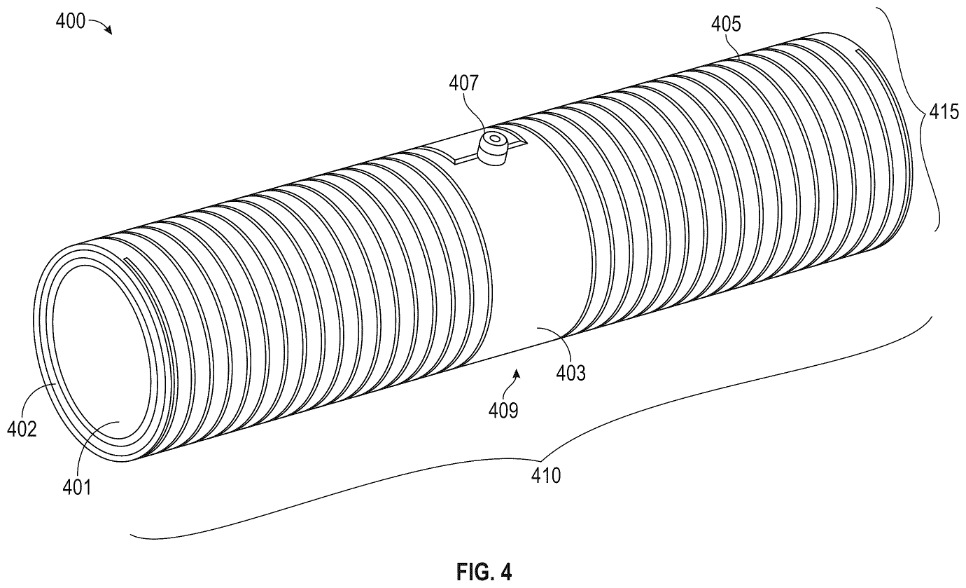

FIG. 3 depicts an oblique view of components of the pipe connection system (195) in accordance with one or more embodiments. Each pipe (181, 182) includes a first connection end (303) and a second connection end (304). The pipe connection system (195) includes a plurality of flanges (e.g., a first flange (305) and a second flange (306)). Each flange (305, 306) is configured to be disposed on one of the pipes. For example, the first flange (305) may be configured to be disposed on the first pipe (181). The second flange (306) may be configured to be disposed on the second pipe (182). In some embodiments, each flange (305, 306) may include a tapered form. For example, each flange (305, 306) may include a first tapered end (309) having a minor diameter and a second tapered end (311) having a major diameter that is larger relative to the minor diameter. The thickness of the flange wall may also taper with the flange wall thinning along a flange axis from the second tapered end (311) to the first tapered end (309). The thickness of the flange wall may be any thickness suitable for securing the connection joint (190) that will withstand the stress, temperature, and pressure exerted on the connection joint (190) which is known by those skilled in the art.

Each flange (305, 306) may be constructed of any material suitable for securing the connection joint (190) that will withstand the stress, temperature, and pressure exerted on the connection joint (190) which is known by those skilled in the art. In some embodiments, each flange (305, 306) may be constructed from a metal or metal alloy material such as, but not limited to, steel or stainless steel. In some embodiments, each flange (305, 306) may be constructed from a polymer material such as, but not limited to, reinforced polymer.

In some embodiments, each flange comprises a rim (310). In some embodiments, each flange (305, 306) includes a plurality of securing holes (312) disposed around the rim (310) for facilitating the securement of the pipe connection system (195). The plurality of securing holes (312) may be spaced equidistant around a periphery of the rim (310). The rim (310) may have any rim thickness suitable for securing the connection joint (190) to withstand the stress and pressure exerted on the connection joint (190) which is known by those skilled in the art.

In some embodiments, the pipe connection system (195) may include one or more seals (e.g., a first seal (307) and a second seal (308)). Each seal (307, 308) is configured to be disposed on one of the connection ends (303, 304) of the pipe (181, 182). For example, the first seal (307) may be disposed on the first connection end (303) and the second seal (308) may be disposed on the second connection end (304). Each seal may be constructed of any material suitable for forming a seal such as rubber and may be in the form of an O-ring but is not limited to this. Each flange (305, 306) may include a seal recess (not shown) on an inner wall of the flange so that when each flange is fastened to another flange, one of the seals (307, 308) may be disposed, at least partially within the seal recess.

FIG. 4 depicts a perspective view of a coupler in accordance with one or more embodiments. The pipe connection system (195) may include a coupler (400). In some embodiments, the coupler (400) may include various layers constructed from polymers and/or reinforced polymers. For example, the couple may include a coupler reinforcement layer (402), and a coupler encapsulating layer (403). In some embodiments, the coupler (400) further includes a coupler inner liner (401). Each layer of the coupler (400) may be constructed similar to the corresponding layers of the reinforced pipe as described in relation to FIG. 2. The coupler (400) includes a coupler outer diameter (415) that is smaller than an inner diameter of the pipe (181, 182) so that a gap between the coupler (400) and the pipe (181, 182) is smaller than a given tolerance. The coupler (400) may be constructed from cutting a custom-made reinforced pipe similar to the reinforced pipe described in relation to FIG. 2. The coupler (400) includes a smaller outer diameter than the pipe (181, 182) and is cut into appropriate lengths for connecting, for example, the first pipe (181) and the second pipe (182) together. The length of the coupler may depend, but not limited to, load cases (pressure), welding requirements, environmental (fluid to be carried and temperature envelope) and other factors known to those skilled in the art. In some embodiments, the coupler inner liner (401) and/or the coupler encapsulating layer (403) may include a non-metallic material. The coupler inner liner (401) is configured to allow flow of the production fluid (121).

In some embodiments, the coupler (400) may be configured to be disposed, at least partially, inside the first connection end (303) and the second connection end (304). The coupler (400) may be disposed, for example, with equal portions of the coupler (400) disposed within the first pipe (181) and the second pipe (182).

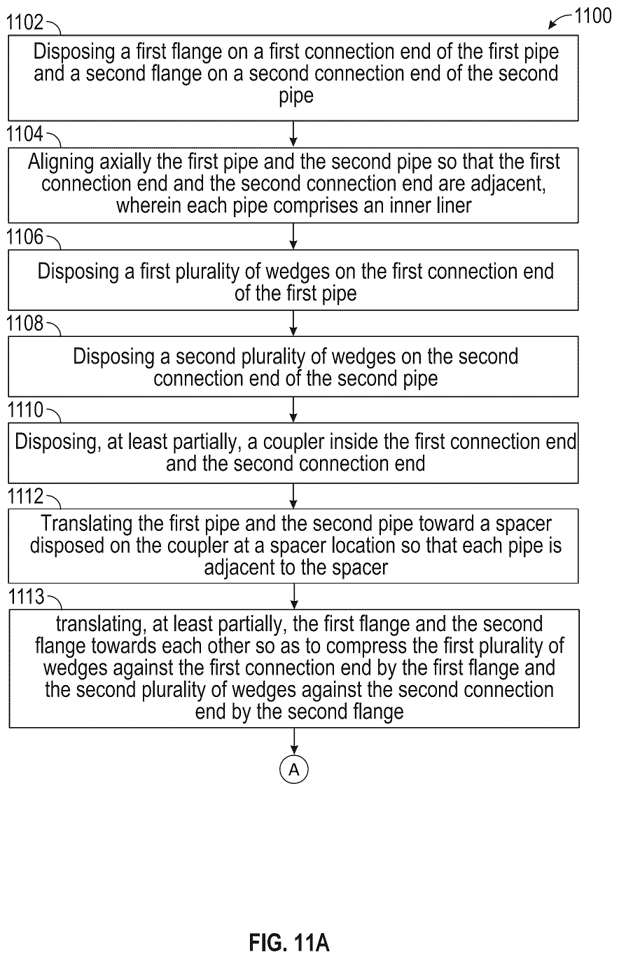

In some embodiments, the coupler (400) includes an embedded coil (405). The embedded coil (405) is wrapped helically around the coupler (400) and is configured to emit heat when a current (e.g., a first current and/or a second current) is applied. A plurality of windings of the embedded coil (405) may be spaced equidistantly apart so as to provide heat evenly to the first connection end (303) and the second connection end (304) of the pipes (181, 182) so the pipe inner liner (202) and the coupler inner liner (401) may be bonded together to form a seal at the connection joint (190). In some embodiments, the embedded coil (405) may include a first embedded portion disposed on and wrapped around a first half of the coupler (400) and a second embedded portion disposed on and wrapped around a second half of the coupler (400). In some embodiments, each portion of the embedded coil (405) may be wrapped around the coupler (400) starting at each end of the coupler (400) and converging at a central location (409) along a coupler axial length (410) of the coupler (400). In some embodiments, each portion of the embedded coil (405) may include one or more wires protruding outward from the coupler (400) in the central location (409) along the coupler axial length (410) and configured to connect to a power supply or an electrode such as electrode (1008) described in relation to FIG. 10.

In some embodiments, the coupler (400) includes an electrical connector (407) configured to receive an electrode such as electrode (1008) described in relation to FIG. 10. The electrical connector (407) may be electrically connected to the embedded coil (405) at the central location (409) along the coupler axial length (410). The electrical connector (407) may be any electrode connector suitable for connecting to an electrode and known to those skilled in the art. In some embodiments, the electrical connector (407) may be one or more wires (not shown) protruding from the embedded coil (405) and are configured to electrically couple with an electrode or a power supply.

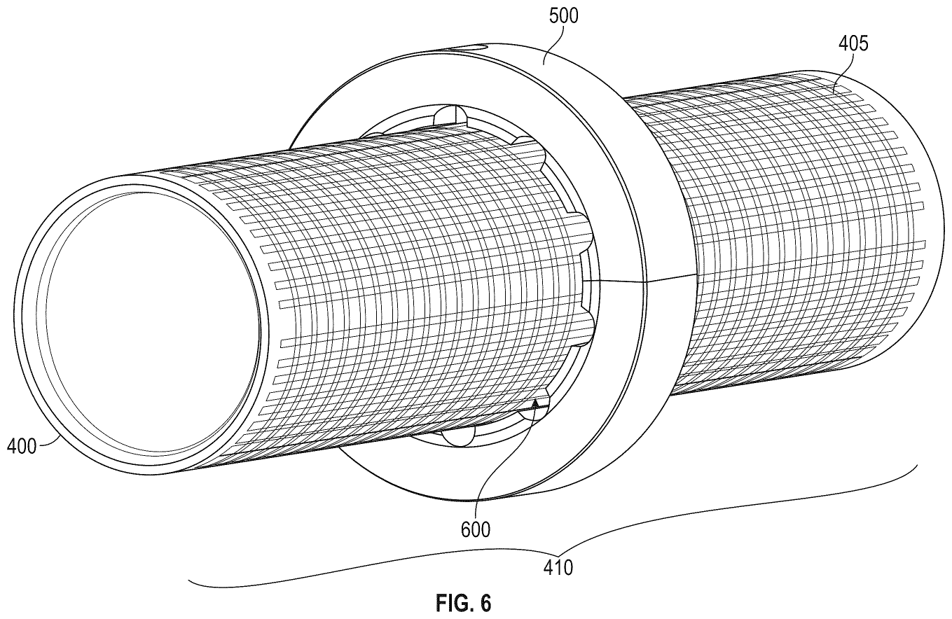

FIG. 5A depicts a perspective view of a spacer (500) that is included in the pipe connection system (195) in accordance with one or more embodiments. The spacer (500) includes a port (e.g., welding port (505)). The welding port (505) may be configured to receive an electrode such as the electrode described in relation to FIG. 10. The welding port (505) may be configured to receive one or more wires extending from the embedded coil (405) in accordance with one or more embodiments. The spacer (500) may include a cavity (506) configured to receive the electrical connector (407) of the coupler (400) in one or more embodiments. In some embodiments, the spacer (500) may include one or more segments (e.g., a first spacer portion (501) and a second spacer portion (503)) configured to circumferentially encompass the coupler outer diameter (415) of the coupler (400) when each portion is connected. The spacer (500) may be disposed at a spacer location along the coupler axial length (410) such as the central location (409). The assembly of the spacer (500) on the coupler outer diameter (415) of the coupler (400) can be done via, but is not limited to, bolting, bonding, welding or overmolding the spacer (500) onto the coupler (400). In some embodiments, a port (e.g., the welding port (505)) may be configured to receive one or more sensors or sensor connections for monitoring the connection joint (190). Based on the disclosure herein, it will be apparent to a person having ordinary skill in the art that a spacer may include more than one port configured to receive, but not limited to, welding electrodes, connectors, probes, sensors, and instrumentation for welding, monitoring, testing, and the like.

In some embodiments, the spacer (500) includes a venting channel (504) radially disposed around a periphery of an inner diameter of the spacer (500). The venting channel (504) may be formed by machining after the spacer (500) is formed or may be pre-molded during formation of the spacer (500).

In some embodiments, the spacer (500) may be constructed from metallic material. In some embodiments, the spacer (500) may be constructed from non-metallic material. When constructed from non-metallic material, the spacer (500) may be formed from reinforced polymeric materials by any suitable technique including filament winding, pultrusion, resin transfer molding (“RTM”), or sheet molding compound (“SMC”) among others. The spacer (500) may be fabricated as a solid single ring and translated and bonded onto the coupler (400) in-factory or on-site, when coupling two pipes (e.g., the pipes (181, 182)) together. In some embodiments, the spacer (500) may include two or more segments (e.g., the first spacer portion (501) and the second spacer portion (503)) and installed (i.e., placed and bonded) on the coupler (400) in-factory or on-site, when coupling two pipes (e.g., the pipes (181, 182)) together.

In some embodiments, the spacer (500) may include geometrical features (not shown) to ensure correct position of each pipe when fully welded, for example, protrusions that interlock with cavities (not shown) disposed on the coupler. The spacer (500) may also include an instrumentation port to add sensing capabilities when needed. The spacer (500) may include connection chambers to enable access to instrumentation and interconnect the anulus of the pipes being connected when needed.

FIG. 5B depicts a cross-sectional view of the spacer (500) in accordance with one or more embodiments. In some embodiments, the spacer (500) may include a plurality of ribs (507) that extend inward of a spacer inner diameter (510). The spacer inner diameter (510) may be any suitable diameter so the spacer (500) may operatively receive the coupler (400) and a gap between the spacer (500) and the coupler (400) is within a suitable gap tolerance and forms a “tight fit” as known to those skilled in the art. The plurality of ribs (507) and the venting channel (504) are configured to vent gases from an annulus formed between the coupler and each pipe once the couple is inserted into each pipe. The venting channel is disposed around the periphery of the spacer inner diameter (510) so as to be fluidly connected to the plurality of ribs (507) once the connection joint (190) is formed.

In some embodiments, the cavity (506) may include any shape suitable to receive the electrical connector (407). The cavity (506) may be machined out after forming the spacer (500) or may be formed from an initial spacer mold when the spacer (500) is initially formed.

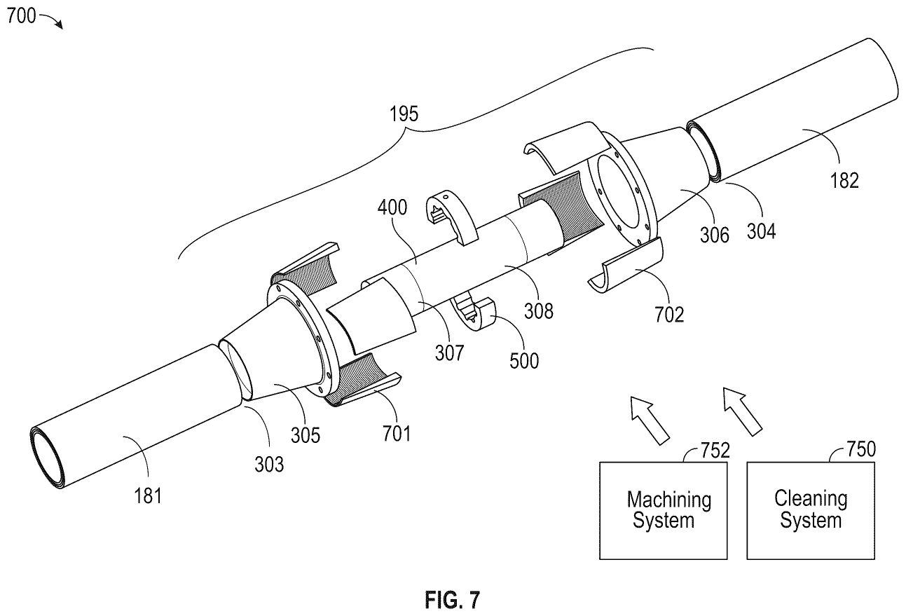

FIG. 6 depicts an oblique view of an assembly of the coupler (400) and the spacer (500) in accordance with one or more embodiments. The spacer (500) may be disposed at the spacer location (600) along the coupler axial length (410). The spacer location (600) may be any location along the coupler axial length (410) suitable to form the connection joint (190) such as the central location (409). In some embodiments, the spacer (500) may be located between the first connector portion and the second connector portion of the embedded coil (405).

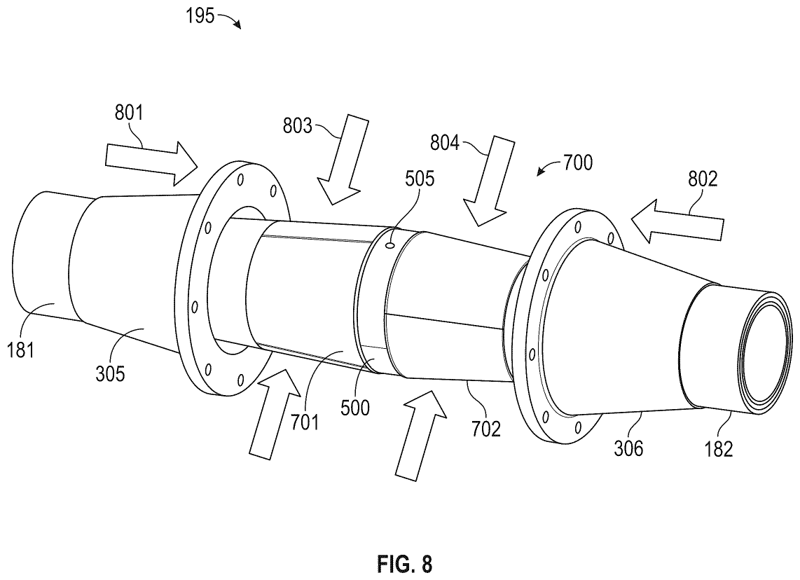

FIG. 7 illustrates an exploded view of the pipe connection system (195) disposed at the connection joint (190) in accordance with one or more embodiments. The pipe connection system (195) includes a plurality of wedges (e.g., a first plurality of wedges (701) and a second plurality of wedges (702)). The plurality of wedges (701, 702) may be configured to be disposed on the pipe (181, 182). For example, the first plurality of wedges (701) may be configured to be disposed circumferentially around the first connection end (303) of the first pipe (181) and the second plurality of wedges (702) is configured to be disposed circumferentially around the second connection end (304) of the second pipe (182). Each wedge of the plurality of wedges (701, 702) may include a tapered form similar to each flange so that each flange may mate with each plurality of wedges (701, 702) to form part of a seal at the connection joint (190). Each wedge of the plurality of wedges (701, 702) may include a larger wedge thickness at one end of the wedge relative to the opposite end of the wedge.

In accordance with one or more embodiments, when the connection joint (190) is assembled, the first seal (307) is configured to seal the connection joint (190) between the first pipe (181) and the spacer. The second seal (308) is configured to seal the connection joint (190) between the second pipe (182) and the spacer (500). Using each seal (307, 308) may yield a sealed connection joint (700). The sealed connection joint (700) may provide protection from the sealed connection joint (700) leaking and/or an external fluid penetrating the sealed connection joint (700). It will be apparent to those skilled in the art that multiple seals may be disposed on each pipe to seal and to prevent moisture or other external fluids penetration into the connection joint (190). For example, multiple seals may be disposed on each pipe end between a plurality of wedges and a pipe to seal and prevent external fluids penetrating into a connection joint.

In some embodiments, the pipe connection system (195) includes a cleaning system (750) configured to clean the coupler encapsulating layer (403) and each pipe inner liner (202) before bonding to form the connection joint (190). The cleaning system (750) may include a cleaning solution configured to, at least partially remove, but are not limited to, grease, dust, dirt, and/or production fluid. The cleaning solution may include a cleaning alcohol and a cloth configured to wipe the cleaning solution on the pipe (181, 182) and the coupler (400) so that the bond between each pipe inner liner (202) and the coupler inner liner (401) may be stronger than if more grease and dirt and the like are present.

In some embodiments, the pipe inner liner (202) may be subjected to some localized machining, using a machining system (752), during the pipe connection process to enhance the circularity and compensate from any ovality introduced by the spooling/residual stresses or other deformation to the circularity of the lined pipe. This process may be done as standard to simplify assembly tolerances and tolerance stacks of the pipe connection system (195). For example, the machining system (752) may be any machining system configured to machine, at least partially, the coupler encapsulating layer (403) and each of the pipe inner liners so as to remove any ovality and simplify assembly tolerances. Assembly tolerances may include ovality of a coupler and connection ends, gap tolerances between a coupler and a connection end, concentricity of a coupler and a connection end, and the like. For example, each connection end may be machined so that the concentricity of the coupler (400) and the connection ends (303) may be concentric within 5% of each other and so that the coupler (400) may be inserted into each connection end (303, 304) without damaging the connection ends (303, 304) and/or the coupler (400). Based on the disclosure herein, it will be apparent to one skilled in the art the various assembly tolerances that exist in order to assemble the connection joint (190) and processes to simplify the assembly tolerances.

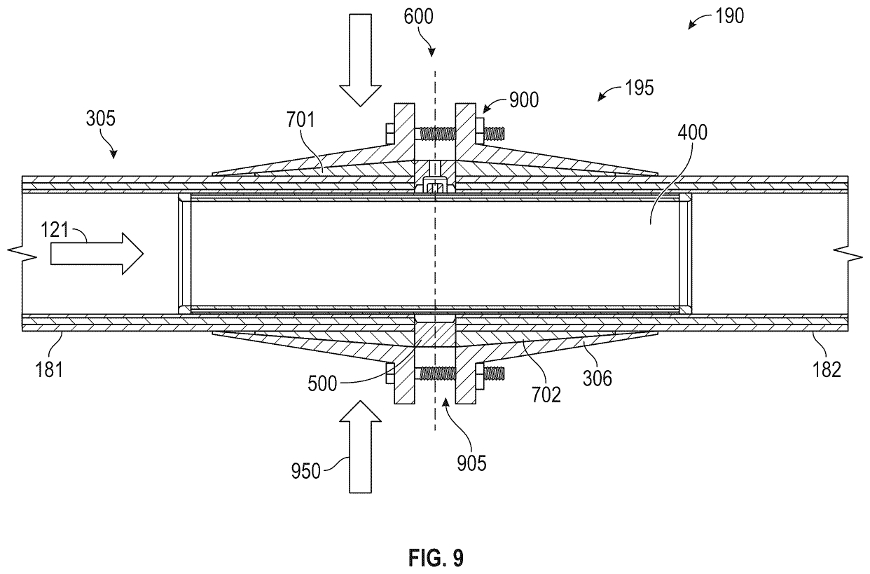

FIG. 8 depicts a perspective view of the pipe connection system (195) in accordance with one or more embodiments. Description of any repeated component of the pipe connection system (195) will not be described again for simplicity and ease of reading. The spacer (500) is disposed circumferentially on the coupler (400), so the cavity (506) receives the electrical connection. The first plurality of wedges (701) is circumferentially disposed on the first connection end (303) of the first pipe (181) and the second plurality of wedges (702) is circumferentially disposed on the second connection end (304) of the second pipe (182). Each flange (305, 306) may receive one of the plurality of wedges (701, 702). Each flange may be translated toward one of the connection ends (303, 304) of the pipe so as to compress one of the plurality of wedges (701, 702) against one of the pipes (181, 182). For example, the first flange (305), and the first plurality of wedges (701) may be disposed on the first pipe (181). The first flange (305) is translated along a pipe axial length of the first pipe (181) yielding a first translation (801). The first flange (305) is configured to compress the first plurality of wedges (701) against the first connection end (303) of the first pipe (181) and exert a first compressional force (803) on the first connection end (303). The second flange (306), and the second plurality of wedges (702) may be disposed on the second pipe (182) opposite to that of the first flange (305) and the first plurality of wedges (701). The second flange (306) may be reversely translated compared to a first translation (801) of the first flange (305) along a pipe axial length of the second pipe (182) yielding a second translation (802). The second flange (306) is configured to compress the second plurality of wedges (702) against the second connection end (304) of the second pipe (182) and exert a second compressional force (804) on the second connection end (304).

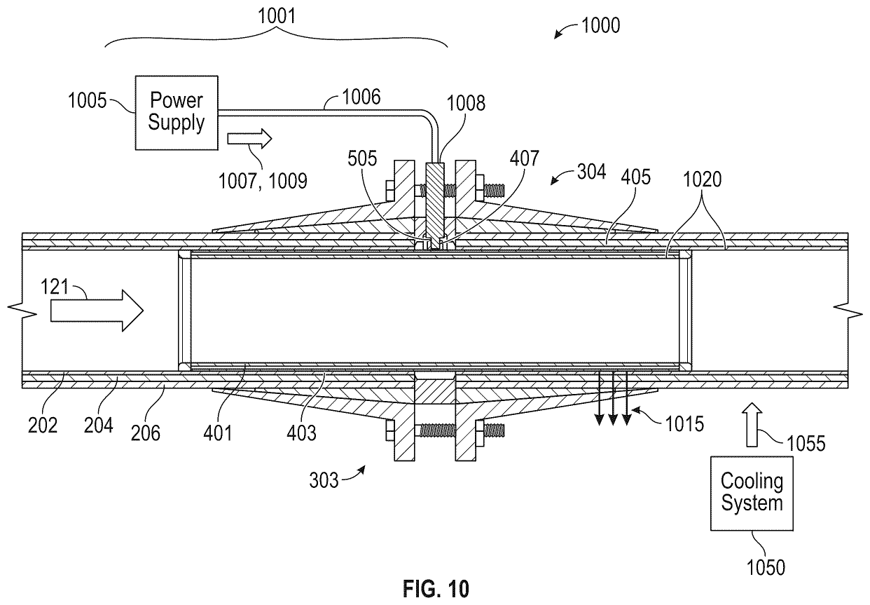

FIG. 9 illustrates an axial cross-sectional view of the pipe connection system (195) at the connection joint (190) in accordance with one or more embodiments. Description of any repeated component of the pipe connection system (195) will not be described again for simplicity and ease of reading. The pipe connection system (195) includes a securing system (900). The securing system (900) is configured to secure the connection joint (190) by further translating the first flange (305) and the second flange (306) to a pre-determined tolerance of compression (950) on each pipe (181, 182). The pre-determined tolerance is dependent on pressure, temperature and materials and may be determined by one skilled in the art. In some embodiments, the securing system (900) includes a plurality of nut and bolt sets (905) configured to secure the connection joint (190) by tightening each of the plurality of nut and bolt sets (905). The securing system (900) is configured to secure the connection joint (190) by tightening each of the plurality of nut and bolt sets (905) to a specified torque. In one or more embodiments, the securing system (900) may include clamps, fasteners, adhesives, and/or welding to secure the pipe connection system (195).

In some embodiments, the securing system (900) is configured to be removed. The securing system (900) may be released, for example, the plurality of nut and bolts sets may be loosened and removed. Each of the first flange (305) and the second flange (306) is configured to translate away from the connection joint (190) along the pipe axial length of one of the pipes (181, 182).

FIG. 10 depicts an axial cross-sectional view of the pipe connection system (195) in accordance with one or more embodiments. The pipe connection system (195) includes a bonding system (1001). The bonding system (1001) may be an electro-fusion welding system in accordance with one or more embodiments. The bonding system (1001) may include a power supply (1005) configured to apply a current (e.g., a first current (1007) and/or a second current (1009)) to the embedded coil (405) the electrical connector (407). The electrical connector may be any electrode connector configured to electrically couple with an electrode or may be protruding wires from the embedded coil (405) to bond the coupler (400) to the first connection end (303) and the second connection end (304) yielding the connection joint (190). The power supply (1005) may supply the current (1007, 1009) via a power line (1006) configured to transport the current (1007, 1009). The power supply (1005) may include a direct power supply configured to supply a direct current. The power supply (1005) may be any power supply suitable to supply the current (1007, 1009) to an electrode.

In some embodiments, the bonding system (1001) includes an electrode (1008) configured to insert into the welding port (505) so that the electrode (1008) is electrically coupled to the electrical connector (407) and applies the first current (1007) to the electrical connector (407). In some embodiments, the embedded coil (405) is configured to emit heat (1015) to bond the coupler encapsulating layer (403) to each of the pipe inner liner (202) of the first pipe (181) and the second pipe (182). The heat (1015) is generated from the current (1007, 1009) passing through the embedded coil (405). In some embodiments, if there is no pipe inner liner, the electrode (1008) is configured to emit heat (1015), thereby melting at least partially the encapsulating layer, to bond the coupler encapsulating layer (403) to each of the pipe reinforcement layer (204) of the first pipe (181) and the second pipe (182).

In accordance with one or more embodiments, the embedded coil (405) is configured to emit the heat (1015) when the first current (1007) is applied to bond the layers of each pipe (181, 182) and the coupler (400). For example, bonding may include melting the pipe inner liner (202) and the coupler encapsulating layer (403) to form a sealed inner surface (1020). The embedded coil (405) may emit the heat (1015) in any direction away from the embedded coil (405). The heat (1015) emitted from the embedded coil (405) may heat any of the various layers such as the pipe inner liner (202) and the coupler encapsulating layer (403) to a melting point of the material that forms the pipe inner liner (202) and/or the coupler encapsulating layer (403). When the material reaches the melting point, the power supply (1005) may be configured to stop the flow of the first current (1007). The material that forms the pipe inner liner (202) and/or the coupler encapsulating layer (403) may be allowed to cool in order to solidify after reaching the melting point yielding a solidified connection joint (1000). The solidified connection joint (1000) is configured to provide a metal-free sealed inner surface (1020). The production fluid (121) flows past the connection joint (190) and does not contact metal thereby the connection joint (190) includes a corrosion-free connection joint.

In some embodiments, the pipe connection system (195) may include a cooling system (1050) configured to cool the material that forms the pipe inner liner (202) and/or the coupler encapsulating layer (403) in order solidify the material that forms the pipe inner liner (202) and/or the coupler encapsulating layer (403). In some embodiments, the cooling system (1050) may include system hardware such as a fan, a heat exchanger, a cooling flow line, a coolant reservoir, and a coolant operatively connected to direct a cooling air flow (1055) toward the connection joint (190). The fan is configured to direct the cooling air flow (1055) toward the connection joint (190). The heat exchanger is operatively connected to the coolant reservoir via the cooling flow line. The coolant reservoir is configured to supply the coolant to the heat exchanger. The heat exchanger is configured to transfer heat between input air to the fan and the coolant so as to cool an input air flow through the fan.

The electrode (1008) is configured to insert into the welding port (505) so that the electrode (1008) is electrically coupled to the electrical connector (407). The power supply (1005) is configured to apply a second current (1009) to the embedded coil (405) to disconnect the connection joint (190). The embedded coil (405) may emit the heat (1015) in any direction away from the embedded coil (405). The heat (1015) emitted from the embedded coil (405) may heat any of the various layers such as the pipe inner liner (202) and the coupler encapsulating layer (403) to a melting point of the material that forms the pipe inner liner (202) and/or the coupler encapsulating layer (403). When the material reaches the melting point sufficient for bonding, the power supply (1005) may be configured to stop the flow of the second current (1009). The coupler (400) is configured to be removed from the first connection end (303) and the second connection end (304) when the material that forms the various layers of each connection end (303, 304) and the coupler (400) reaches the melting point sufficient for bonding.

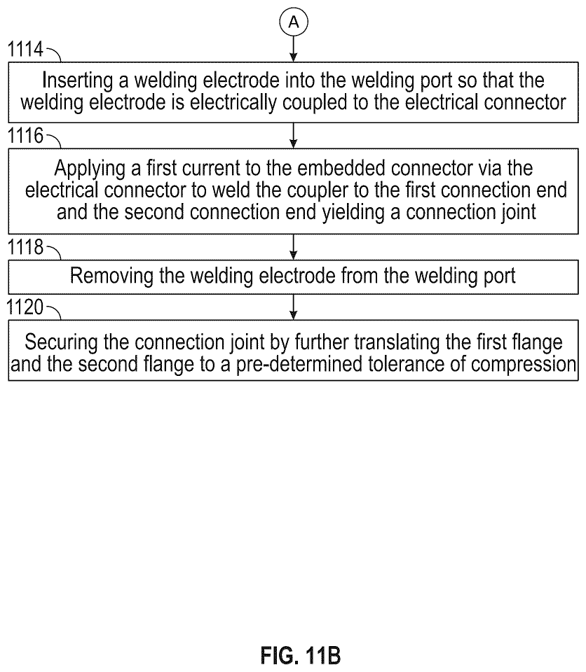

FIG. 11A to FIG. 11B depict a flowchart in accordance with one or more embodiments describing a method for connecting a first pipe and a second pipe to form a pipeline (hereafter “pipe connection method” (1100)). In some embodiments, the pipe connection method (1100) may use the pipe connection system (195). Although the steps in flowchart using the pipe connection method (1100) are shown in sequential order, it will be apparent to one of ordinary skill in the art that some steps may be conducted in parallel, in a different order than shown, or may be omitted without departing form the scope of the invention.

In box (1102), the pipe connection method (1100) includes disposing the first flange (305) on the first connection end (303) of the first pipe (181) and the second flange (306) on the second connection end (304) of the second pipe (182) in accordance with one or more embodiments. The first flange (305) and the second flange (306) may be translated along each pipe (181, 182) away from each connection end (303, 304) so that other components of the pipe connection system (195) may be disposed on each connection end (303, 304).

In box (1104), the pipe connection method (1100) includes aligning axially the first pipe (181) having the first connection end (303) and the second pipe (182) having the second connection end (304) so that the first connection end (303) and the second connection end (304) are adjacent in accordance with one or more embodiments. Aligning axially the first connection end (303) and the second connection end (304) may be done using components of the pipe connection system (195) or a tool configured to align multiple pipes.

In box (1106), the pipe connection method (1100) includes disposing the first plurality of wedges (701) on the first connection end (303) of the first pipe (181) in accordance with one or more embodiments. The first plurality of wedges (701) is disposed circumferentially around the first connection end (303).

In box (1108), the pipe connection method (1100) includes disposing the second plurality of wedges (702) on the second connection end (304) of the second pipe (182) in accordance with one or more embodiments. The second plurality of wedges (702) is disposed circumferentially around the second connection end (304).

In box (1110), the pipe connection method (1100) includes disposing, at least partially, the coupler (400) inside the first connection end (303) and the second connection end (304) in accordance with one or more embodiments. Disposing the coupler (400) inside the first connection end (303) and the second connection end (304) may include disposing equal portions of the coupler (400) inside the first connection end (303) and the second connection end (304).

In box (1112), the pipe connection method (1100) includes translating the first pipe (181) and the second pipe (182) toward the spacer (500) disposed on the coupler (400) at the spacer location (600) so that each pipe (181, 182) is adjacent to the spacer (500) in accordance with one or more embodiments. In some embodiments, disposing the spacer (500) may include placing the first spacer portion (501), and the second spacer portion (503) so as to circumferentially encompasses the coupler (400) at the spacer location (600). In some embodiments, the spacer (500) may be disposed and bonded on the coupler (400) as part of the manufacturing process of the coupler (400). In some embodiments, the spacer (500) may be disposed on the coupler during the pipe connection method (1100) on-site.

In box (1113), the pipe connection method (1100) includes translating, at least partially, the first flange (305) and the second flange (306) towards each other so as to compress the first plurality of wedges (701) against the first connection end (303) by the first flange (305) and the second plurality of wedges (702) against the second connection end (304) by the second flange (306) in accordance with one or more embodiments.

In box (1114), the pipe connection method (1100) includes inserting the electrode (1008) into the welding port (505) so that the electrode (1008) is electrically coupled to the electrical connector (407) in accordance with one or more embodiments. In some embodiments, the electrical connector (407) may be any electrode connector configured to electrically couple with the electrode (1008). In some embodiments, the electrical connector (407) may be the protruding wires from the embedded coil (405) and configured to be electrically coupled to the electrode (1008) or the power supply (1005).

In box (1116), the pipe connection method (1100) includes applying, using the power supply (1005), the first current (1007) to the embedded coil (405) via the electrical connector (407) to bond the coupler (400) to the pipe inner liner (202) at the first connection end (303) and the second connection end (304) yielding the connection joint (190) in accordance with one or more embodiments. In some embodiments, bonding the first connection end (303) and the second connection end (304) may include emitting heat (1015), thereby melting the coupler encapsulating layer at least partially, to bond the coupler encapsulating layer (403) to the pipe inner liner (202).

In box (1118), the pipe connection method (1100) includes removing the electrode (1008) from the welding port (505) in accordance with one or more embodiments. The electrode (1008) is removably coupled to the electrical connector (407) such as an electrode connector or the protruding wires of the embedded coil (405).

In box (1120), the pipe connection method (1100) includes securing, using the securing system (900), the connection joint (190) by further translating the first flange (305) and the second flange (306) to the pre-determined tolerance of compression (950) in accordance with one or more embodiments. In some embodiments, the securing system (900) includes the plurality of nut and bolt sets (905) configured to secure the connection joint (190) by tightening each of the plurality of nut and bolt sets (905). In some embodiments, the pipe connection method (1100) may include securing the connection joint (190) comprises tightening each of the plurality of nut and bolt sets (905) to a specified torque. The specified torque may be dependent on the pipe outer diameter, pressure and temperature, and materials used and may be determined by those skilled in the art.

In some embodiments, the pipe connection method (1100) may include flowing a production fluid (121) within the pipe inner liner (202) and the coupler inner liner (401) in accordance with one or more embodiments. The production fluid (121) flows past the connection joint (190) and does not contact metal thereby the connection joint (190) includes the corrosion-free connection joint. Flowing the production fluid (121) may include flowing the production fluid past the solidified connection joint (1000) prohibiting corrosive interaction with the metal-free sealed inner surface (1020) and the production fluid (121).

In some embodiments, the pipe connection method (1100) may include cleaning, at least partially, using the cleaning system (750), the coupler encapsulating layer (403) and each of the pipe inner liner (202). Cleaning the coupler encapsulating layer (403) and each of the pipe inner liner (202) may include wiping a cleaning solution on the coupler encapsulating layer (403)

In some embodiments, the pipe connection method (1100) may include removing the securing system (900). Removing the securing system (900) may include loosening the plurality of nut and bolt sets (905) and then removing the plurality of nut and bolt sets (905). The pipe connection method (1100) may include translating the first flange (305) and the second flange (306) away from the connection joint (190).

In some embodiments, the pipe connection method (1100) may include inserting the electrode (1008) into the welding port (505) so that the electrode (1008) is electrically coupled to the electrical connector (407). The pipe connection method (1100) may include applying, using the power supply (1005), the second current (1009) to the embedded coil (405) to disconnect the connection joint (190). The pipe connection method (1100) may include removing the coupler (400) from the first connection end (303) and the second connection end (304).

In some embodiments, the pipe connection method (1100) may include disposing the first seal (307) on the first connection end (303) and the second seal (308) on the second connection end (304). In some embodiments, the first seal (307) is disposed on the first pipe (181) to seal the connection joint (190) between the spacer (500) and the first pipe (181) and the second seal (308) is disposed on the second pipe (182) to seal the connection joint (190) between the spacer (500) and the second pipe (182) yielding the sealed connection joint (700). The sealed connection joint is to provide protection from the sealed connection joint leaking production fluids and/or from leaks of production fluid. It will be apparent to those skilled in the art that multiple seals may be used to further seal the connection joint (190). For example, a seal may be disposed on the first pipe (181) to seal the connection joint (190) with the first plurality of wedges (701) and the first pipe (181). Another seal is disposed on the second pipe (182) to seal the connection joint (190) with the second plurality of wedges (702) and the second pipe (182). The sealed connection joint (700) may provide protection from an external fluid penetrating the sealed connection joint (700).

In some embodiments, the pipe connection method (1100) may include cooling, using the cooling system (1050), the connection joint (190) yielding the solidified connection joint (1000). Cooling the connection joint may include directing cool air from the cooling system (1050) toward the connection joint (190).

Embodiments of the present disclosure may provide at least one of the following advantages. The disclosed invention provides pipe connections that alleviate corrosion issues, apparent with metallic connections. The disclosed invention provides improved pipe connections the alleviate from failures due to mechanical or thermal loads, potentially occurring in thermoplastic connections. The disclosed invention provides pipe connections that alleviate the usage of O-rings and provide optimal sealing, as observed only with systems capable of thermoplastic welding. The disclosed invention provides a simplified design compared to the prior art, as the coupler can be manufactured in continuous form using the same technology as the pipes. The disclosed invention enables electro-fusion welding which is highly automatable and robust enabling the de-skilling of the process.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for connecting a first pipe and a second pipe to form a pipeline, the method comprising:
disposing a first flange on a first connection end of the first pipe and a second flange on a second connection end of the second pipe;
aligning axially the first pipe and the second pipe so that the first connection end and the second connection end are adjacent, wherein each pipe comprises an inner liner;
disposing a first plurality of wedges on the first connection end of the first pipe,
wherein the first plurality of wedges is disposed circumferentially around the first connection end;
disposing a second plurality of wedges on the second connection end of the second pipe,
wherein the second plurality of wedges is disposed circumferentially around the second connection end;
disposing, at least partially, a coupler inside the first connection end and the second connection end,
wherein the coupler comprises an electrical connector and an embedded coil, wherein the embedded coil is wrapped circumferentially around the coupler and is configured to emit heat when a first current is applied;
translating the first pipe and the second pipe toward a spacer disposed on the coupler at a spacer location so that each pipe is adjacent to the spacer,
wherein the spacer comprises a welding port and a cavity, wherein the cavity is configured to receive the electrical connector;
translating, at least partially, the first flange and the second flange towards each other so as to compress the first plurality of wedges against the first connection end by the first flange and the second plurality of wedges against the second connection end by the second flange;
inserting an electrode into the welding port so that the electrode is electrically coupled to the electrical connector;
applying, using a power supply, a first current to the embedded coil via the electrical connector bonding the coupler to the inner liner of each of the first pipe and the second pipe yielding a connection joint;
removing the electrode from the welding port; and
securing, using a securing system, the connection joint by further translating the first flange and the second flange to a pre-determined tolerance of compression.

2. The method of claim 1,
wherein each coupler comprises a coupler inner liner, a coupler reinforcement layer, and a coupler encapsulating layer, and
wherein each pipe comprises a pipe inner liner, a pipe reinforcement layer, and a pipe encapsulating layer,
wherein bonding each of the pipe inner liners and the coupler comprises emitting heat, using the electrode, to bond the coupler encapsulating layer to each of the pipe inner liner of the first pipe and the second pipe.

3. The method of claim 2,
wherein each of the pipe inner liner and the coupler inner liner comprises a non-metallic material;
the method further comprising:
flowing a production fluid within the pipe inner liner and the coupler inner liner,
wherein the production fluid flows past the connection joint and does not contact metal thereby the connection joint comprises a corrosion-free connection joint.

4. The method of claim 2, further comprising:
machining, at least partially, using a machining system, the coupler encapsulating layer and each of the pipe inner liners so as to remove any ovality and simplify assembly tolerances.

5. The method of claim 1,
wherein the spacer comprises a first spacer portion and a second spacer portion circumferentially encompasses the coupler at the spacer location.

6. The method of claim 1,
wherein the securing system comprises a plurality of nut and bolt sets configured to secure the connection joint by tightening each of the plurality of nut and bolt sets,
wherein securing the connection joint comprises tightening each of the plurality of nut and bolt sets to a specified torque.

7. The method of claim 1, further comprising:
removing the securing system;
translating the first flange and the second flange away from the connection joint;
inserting the electrode into the welding port so that the electrode is electrically coupled to the electrical connector;
applying, using the power supply, a second current to the embedded coil to disconnect the connection joint; and
removing the coupler from the first connection end and the second connection end.

8. The method of claim 1, further comprising:
disposing a first seal on the first connection end and a second seal on the second connection end; and
wherein the first seal is configured to seal the connection joint between the spacer and the first pipe and the second seal is configured to seal the connection joint between the spacer and the second pipe yielding a sealed connection joint;
wherein the sealed connection joint is to provide protection from leaks of production fluid.

9. The method of claim 1, further comprising:
cooling, using a cooling system, the connection joint yielding a solidified connection joint.

10. A system for connecting a first pipe and a second pipe to form a pipeline, the system comprising:
a first flange configured to be disposed on the first pipe having a first connection end;
a second flange configured to be disposed on the second pipe having a second connection end;
a first plurality of wedges configured to be disposed circumferentially around the first connection end of the first pipe;
a second plurality of wedges configured to be disposed circumferentially around the second connection end of the second pipe;
wherein the first flange is configured to compress the first plurality of wedges against the first connection end,
wherein the second flange is configured to compress the second plurality of wedges against the second connection end by the second flange;
a coupler configured to be disposed inside the first connection end and the second connection end;
wherein the coupler comprises an electrical connector and an embedded coil, wherein the embedded coil is wrapped circumferentially around the coupler and is configured to emit heat when a first current is applied;
a spacer configured to be disposed at a spacer location along the coupler between the first connection end and the second connection end;
wherein the spacer comprises a welding port and a cavity, wherein the cavity is configured to receive the electrical connector;
an electrode configured to insert into the welding port so that the electrode is electrically coupled to the electrical connector and apply the first current to the electrical connector;
a power supply configured to apply the first current to the embedded coil via the electrical connector to bond the coupler to the first connection end and the second connection end yielding a connection joint; and
a securing system configured to secure the connection joint by further translating the first flange and the second flange to a pre-determined tolerance of compression.

11. The system of claim 10,
wherein each coupler comprises a coupler inner liner, a coupler reinforcement layer, and a coupler encapsulating layer, and
wherein each pipe comprises a pipe inner liner, a pipe reinforcement layer, and a pipe encapsulating layer;
wherein the electrode is configured to apply heat to bond the coupler encapsulating layer to each of the pipe inner liner of the first pipe and the second pipe.

12. The system of claim 11,
wherein each of the pipe inner liner and the coupler inner liner comprises a non-metallic material, and
wherein the pipe inner liner and the coupler inner liner are configured to allow flow of a production fluid;
wherein the production fluid flows past the connection joint and does not contact metal thereby the connection joint comprises a corrosion-free connection joint.

13. The system of claim 11, further comprising:
a machining system configured to machine the coupler encapsulating layer and each of the pipe inner liners so as to remove any ovality and simplify assembly tolerances.

14. The system of claim 10,
wherein the spacer comprises a first spacer portion and a second spacer portion configured to circumferentially encompass the coupler at the spacer location.

15. The system of claim 10,
wherein the securing system comprises a plurality of nut and bolt sets configured to secure the connection joint by tightening each of the plurality of nut and bolt sets,
wherein the securing system is configured to secure the connection joint by tightening each of the plurality of nut and bolt sets to a specified torque.

16. The system of claim 10, further comprising:
wherein the securing system is configured to be removed,
wherein each of the first flange and the second flange is configured to translate away from the connection joint;
the electrode configured to insert into the welding port so that the electrode is electrically coupled to the electrical connector, and
wherein the power supply is configured to apply a second current to the embedded coil to disconnect the connection joint,
wherein the coupler is configured to be removed from the first connection end and the second connection end.

17. The system of claim 10, further comprising:
a first seal configured to be disposed on the first connection end and a second seal
configured to be disposed on the second connection end; and
wherein the first seal is configured to seal the connection joint with between the spacer and the first pipe and the second seal is configured to seal the connection joint between the spacer and the second pipe yielding a sealed connection joint,
wherein the sealed connection joint is to provide protection from leaks of production fluid.

18. The system of claim 10, further comprising:
a cooling system configured to cool the connection joint yielding a solidified connection
joint.

19. A spacer comprises:
a welding port configured to receive an electrode;
a cavity configured to receive an electrical connector of a coupler; and
an inner diameter, wherein the spacer is configured to receive the coupler within the inner diameter.

20. The spacer of claim 19, further comprising:
a plurality of ribs that extend inward of the inner diameter; and
a venting channel radially disposed around a periphery of the inner diameter,
wherein the plurality of ribs and the venting channel are configured to vent gases from an annulus formed between the coupler and each pipe.
